(19) United States
(12) Patent Application Publication
(10) Pub. No.: US 2026/0303791 A1
(43) Pub. Date: Oct. 1, 2026

(54) VIDEO ENCODING/DECODING METHOD AND APPARATUS USING GEOMETRIC PARTITIONING MODE BASED ON INTRA-PREDICTION

(71) Applicants: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(72) Inventors: Dong Gyu SIM, Seoul (KR); Min Hun LEE, Uijeongbu-si, Gyeonggi-do (KR); Han Sol CHOI, Dongducheon-si, Gyeonggi-do (KR); Jung Ah CHOI, Seoul (KR); Jin HEO, Yongin-si, Gyeonggi-do (KR); Seung Wook PARK, Yongin-si, Gyeonggi-do (KR)

(73) Assignees: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(21) Appl. No.: 19/475,874

(22) PCT Filed: Apr. 16, 2024
(86) PCT No.: PCT/KR2024/005096

§ 371 Date: Oct. 16, 2025

(30) Foreign Application Priority Data
Apr. 20, 2023 (KR) 10-2023-0051735
Apr. 12, 2024 (KR) 10-2024-0049589

(51) Int. Cl. H04N 19/11; H04N 19/105; H04N 19/176

(52) U.S. Cl. CPC H04N 19/11; H04N 19/105; H04N 19/176

(57) ABSTRACT

The present disclosure discloses video encoding/decoding methods and apparatus and provides a video decoding method including partitioning a current block into a first region and a second region, generating a combined candidate list of intra-prediction modes for the first region and second region based on at least one of reference blocks adjacent to the current block, a geometric partition boundary, or a third region adjacent to the current block, determining an intra-prediction mode of the first region and an intra-prediction mode of the second region by using the combined candidate list of intra-prediction modes, generating prediction blocks of the first region and second region by using the intra-prediction mode of the first region and the intra-prediction mode of the second region, and generating a prediction block of the current block by using the prediction blocks of the first region and second region.

### CROSS-REFERENCE TO RELATED APPLICATION

This application claims priority from Korean Patent Application No. 10-2023-0051735 filed on Apr. 20, 2023, and Korean Patent Application No. 10-2024-0049589 filed on Apr. 12, 2024, the disclosures of which are incorporated by reference herein in their entirety.

### TECHNICAL FIELD

The present disclosure in some embodiments relates to a video encoding/decoding method and apparatus using a geometric partitioning mode that is based on intra prediction. More particularly, the present disclosure relates to a video encoding/decoding method and apparatus, responsive to when a geometric partitioning mode is applied to a current block, using a combined candidate list of intra-prediction modes for partitioned regions to determine an intra-prediction mode of each region and generate a prediction block of the current block.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

The geometric partitioning mode is a method of partitioning a coding unit (CU) into two regions, performing inter prediction on the two regions independently, generating two inter-prediction signals, and calculating a weighted average of the two inter-prediction signals to generate the prediction block of the current block. When intra prediction is applied to each region in the geometric partitioning mode, there is a need to construct a combined candidate list of intra-prediction modes to improve the encoding efficiency and decoding efficiency.

### DISCLOSURE

### Technical Problem

The present disclosure in some embodiments seeks to provide methods and apparatus using the directionality, an offset, and others of a geometric partition boundary in a geometric partitioning mode to generate a combined candidate list of intra-prediction modes for partitioned regions.

Further, the present disclosure seeks to provide methods and apparatus using an index parsed in a geometric partitioning mode to determine an intra-prediction mode of each of regions from a combined candidate list of intra-prediction modes for the respective partitioned regions.

The present disclosure further seeks to provide methods and apparatus for increasing video encoding/decoding efficiency.

The present disclosure further seeks to provide a recording medium storing a bitstream generated by video encoding/decoding methods or apparatus of the present disclosure.

The present disclosure further seeks to provide a method and apparatus for transmitting a bitstream generated by the video encoding/decoding methods or apparatus of the present disclosure.

### SUMMARY

The present disclosure in at least one embodiment provides a video decoding method, including partitioning a current block into a first region and a second region, generating a combined candidate list of intra-prediction modes for the first region and the second region based on at least one of a set of reference blocks adjacent to the current block, a geometric partition boundary of the current block, or a third region adjacent to the current block, determining an intra-prediction mode of the first region and an intra-prediction mode of the second region by using the combined candidate list of intra-prediction modes, generating a prediction block of the first region and a prediction block of the second region by using the intra-prediction mode of the first region and the intra-prediction mode of the second region, and generating a prediction block of the current block by using the prediction block of the first region and the prediction block of the second region.

The present disclosure in another embodiment provides a video encoding method, including partitioning a current block into a first region and a second region, generating a combined candidate list of intra-prediction modes for the first region and the second region based on at least one of a set of reference blocks adjacent to the current block, a geometric partition boundary of the current block, or a third region adjacent to the current block, determining an intra-prediction mode of the first region and an intra-prediction mode of the second region by using the combined candidate list of intra-prediction modes, generating a prediction block of the first region and a prediction block of the second region by using the intra-prediction mode of the first region and the intra-prediction mode of the second region, and generating a prediction block of the current block by using the prediction block of the first region and the prediction block of the second region.

Further, the present disclosure provides a method of transmitting a bitstream generated by the video encoding methods or apparatus according to the present disclosure.

Further, the present disclosure provides a recording medium storing a bitstream generated by the video encoding methods or apparatus according to the present disclosure.

Further, the present disclosure provides a recording medium storing a bitstream that is received, decoded, and utilized to reconstruct a video by the video decoding apparatus according to the present disclosure.

### Advantageous Effects

As described above, the present disclosure in some embodiments can provide methods and apparatus using the directionality, an offset, and others of a geometric partition boundary in a geometric partitioning mode to generate a combined candidate list of intra-prediction modes for partitioned regions.

Further, the present disclosure can provide methods and apparatus using an index parsed in a geometric partitioning mode to determine an intra-prediction mode of each of regions from a combined candidate list of intra-prediction modes for the respective partitioned regions.

Further, the present disclosure can provide methods and apparatus for increasing video encoding/decoding efficiency.

Effects obtainable with the present disclosure are not limited to the above-mentioned effect, and other unmentioned effects could be clearly understood by those skilled in the art from the description below.

### BRIEF DESCRIPTION OF THE DRAWINGS

FIG. 1 is a block diagram of a video encoding apparatus that may implement the techniques of the present disclosure.

FIG. 2 illustrates a method for splitting a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating a method of applying a geometric partitioning mode to a 32×32 block, according to at least one embodiment of the present disclosure.

FIG. 7A and FIG. 7B are diagrams illustrating angle parameters and distance parameters in a geometric partitioning mode, according to at least one embodiment of the present disclosure.

FIG. 8 is a diagram illustrating a look-up table of partitioning direction information in a geometric partitioning mode, according to at least one embodiment of the present disclosure.

FIG. 9 is a diagram illustrating reconstructed neighbor blocks of a current block, according to at least one embodiment of the present disclosure.

FIG. 10A, FIG. 10B, FIG. 10C, and FIG. 10D are diagrams illustrating methods of generating a combined candidate list of intra-prediction modes for respective regions in a geometric partitioning mode, according to some embodiments of the present disclosure.

FIG. 11 is a diagram illustrating a current block and a template according to at least one embodiment of the present disclosure.

FIG. 12A, FIG. 12B, FIG. 12C, and FIG. 12D are diagrams illustrating methods of generating a combined candidate list of intra-prediction modes for respective regions in a geometric partitioning mode, according to other embodiments of the present disclosure.

FIG. 13A, FIG. 13B, FIG. 13C, and FIG. 13D are diagrams illustrating methods of generating a combined candidate list of intra-prediction modes for respective regions in a geometric partitioning mode, according to yet other embodiments of the present disclosure.

FIG. 14 is a flowchart of a process for generating a prediction block of a current block by using an intra prediction-based geometric partitioning mode according to at least one embodiment of the present disclosure.

FIG. 15 is a flowchart of a process of generating a prediction block of a current block by using an intra prediction-based geometric partitioning mode according to another embodiment of the present disclosure.

FIG. 16 is a flowchart of a video decoding process according to at least one embodiment of the present disclosure.

FIG. 17 is a flowchart of a video encoding process according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

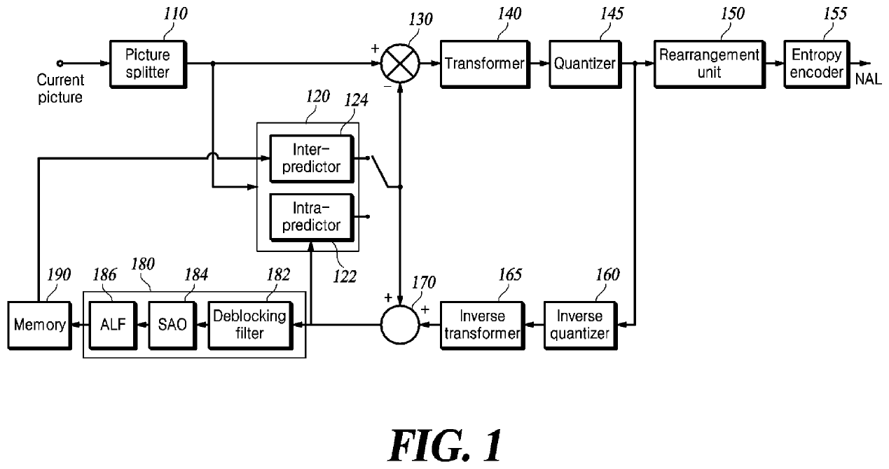

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

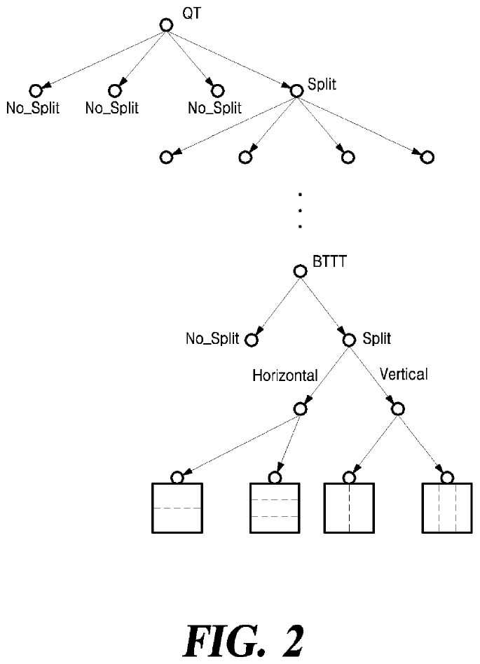

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

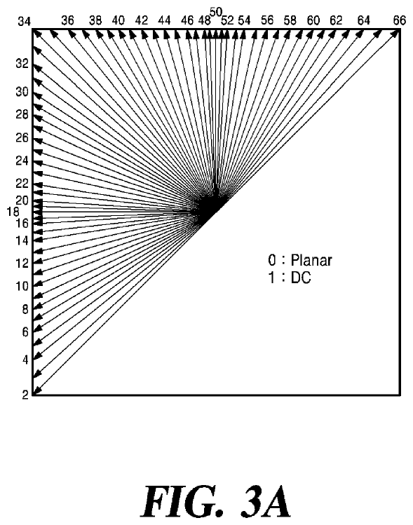

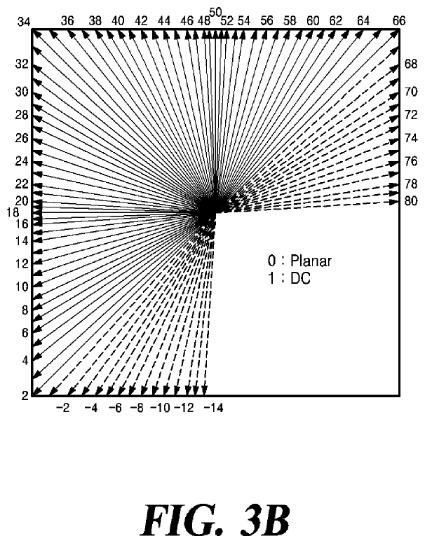

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

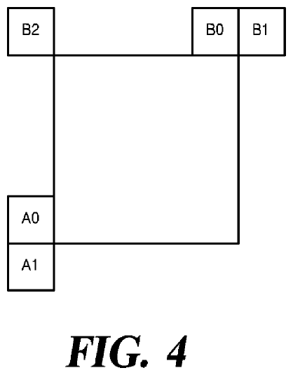

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding apparatus may store a bitstream of encoded video data in a non-transitory storage medium or transmit the bitstream to the video decoding device through a communication network.

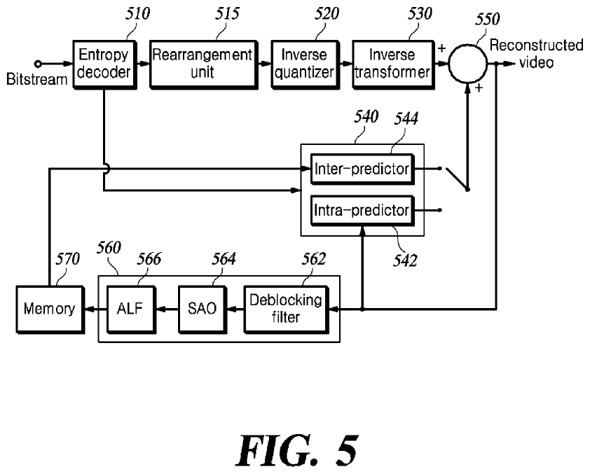

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The following embodiments may be performed by various components in the video encoding apparatus. In addition, they may be performed by various components in the video decoding apparatus.

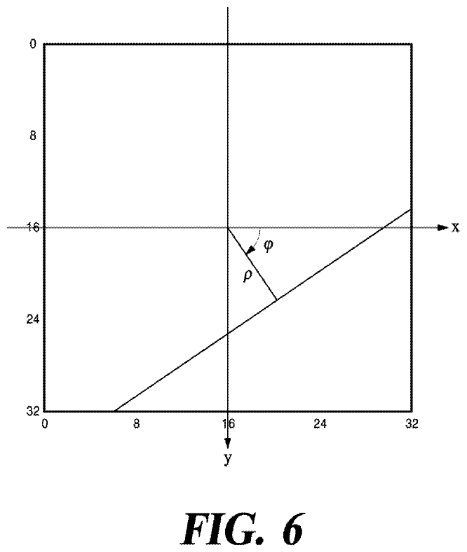

FIG. 6 is a diagram illustrating a method of applying a geometric partitioning mode to a 32×32 block, according to at least one embodiment of the present disclosure. This diagram is for explaining a method of applying the geometric partitioning mode to a 32×32 block. According to the geometric partitioning mode, one coding unit may be partitioned into two regions by a straight partition boundary. The two partitioned regions may undergo inter prediction by using different motion information items, respectively. This will generate inter-prediction blocks for the two partitioned regions, respectively. A weighted average calculated from the two generated inter-prediction blocks can generate the final prediction block in the geometric partitioning mode. The geometric partitioning mode sets a partition boundary region defined by a straight line by using an angle parameter and a distance parameter.

Referring to FIG. 6, the 32×32-block may be partitioned into two regions. Inter prediction may be performed for each of the two partitioned regions. φ may be an angle parameter. ρ may be a distance parameter. A straight line may be established to partition the 32×32 block by using the angle parameter and the distance parameter.

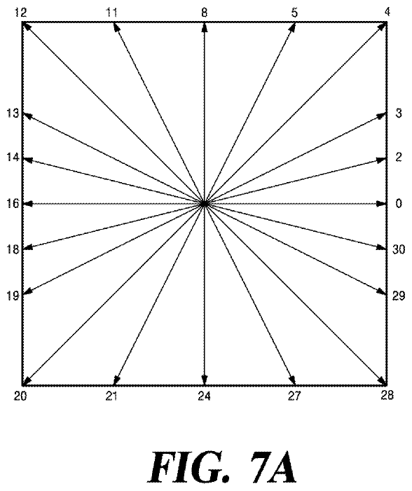

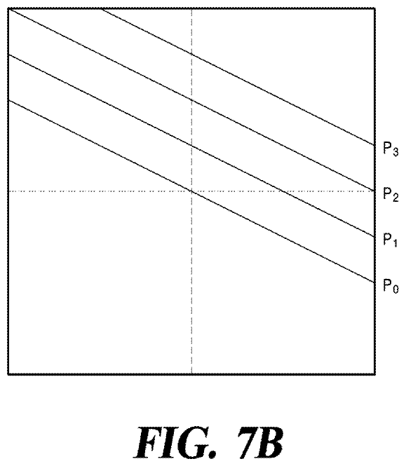

FIG. 7A and FIG. 7B are diagrams illustrating angle parameters and distance parameters in the geometric partitioning mode, according to at least one embodiment of the present disclosure.

Referring to FIG. 7A, the angle parameter may be defined as a total of 20 quantized angles by symmetrically dividing a 360-degree range within a coding unit.

Referring to FIG. 7B, the distance parameter may be defined as 4 quantized distances. Excluded from a total of 80 partitioning directions that can be generated by combining angle parameters and distance parameters, may be 10 overlapping partitioning directions and 6 overlapping partitioning directions between binary tree partition and ternary tree partition. Accordingly, the geometric partition mode may use a total of 64 partitioning directions.

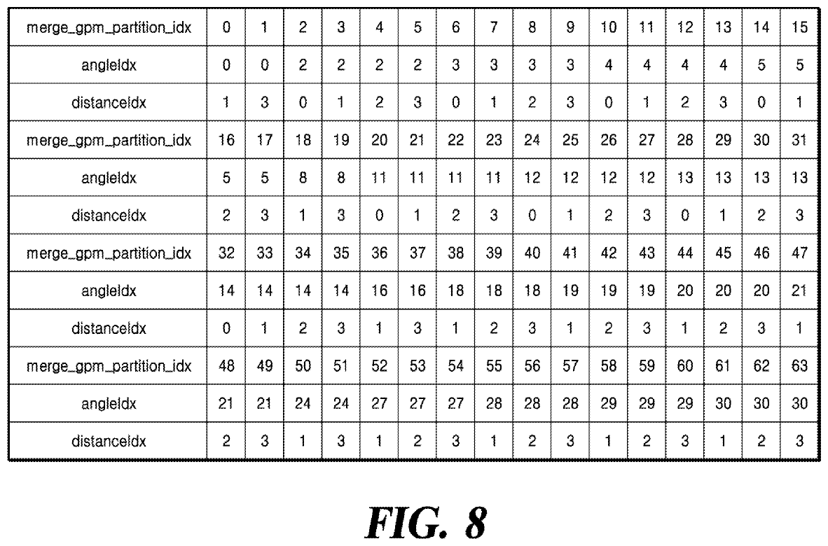

FIG. 8 is a diagram illustrating a look-up table of partitioning direction information in the geometric partition mode, according to at least one embodiment of the present disclosure. Combinations of angle parameters and distance parameters may be defined as a look-up table. Partitioning direction information may be transmitted for each coding unit. The geometric partition mode may construct a merge candidate list for the geometric partition mode that includes only unidirectional motion information from a regular merge candidate list. This can simplify the encoding of motion information and reduce the number of possible combinations of the angle parameters and distance parameters. The merge index used for each partition region may be transmitted by using the merge candidate list for the geometric partition mode.

Referring to FIG. 8, according to the information on the angle parameter (e.g., angleldx) and the information on the distance parameter (e.g., distanceldx), the partitioning direction information (e.g., merge_gpm_partition_idx) may be determined. The merge_gpm_partition_idx according to the combination of angleldx and distanceldx may be defined as a look-up table. The value of merge_gpm_partition_idx may be in the range of 0 to 63. The merge_gpm_partition_idx may be transmitted per coding unit.

### Inter Prediction and Geometric Partitioning Mode (GPM) Using Intra Prediction

When the GPM using inter prediction and intra prediction is applied, the final predicted sample is generated by weighed-summing the samples generated by performing inter prediction and intra prediction on each of regions. Here, the intra prediction sample is generated by using the combined candidate list of intra-prediction modes and the index. The size of the combined candidate list of intra-prediction modes may be predefined as 3. The available candidates of the combined candidate list of intra-prediction modes may be a parallel mode with the geometric partition boundary, a perpendicular mode to the geometric partition boundary, and a planar mode with respect to the geometric partition boundary. The width of the region subject to the weighted summation may be determined by the signaled index.

### Spatial Geometric Partitioning Mode (SGPM)

SGPM is a mode that applies different intra-prediction modes to each of the two partitioned regions. The video encoding apparatus signals partitioning direction information and an index of a candidate list of two intra-prediction modes combined for the two partitioned regions. A template is used to generate the candidate list of two intra-prediction modes combined, but to reduce the complexity of constructing the candidate list of the two intra-prediction modes combined, 26 out of 64 partition modes are used, and among the 67 intra-prediction modes, the intra-prediction mode derived by most probable mode (MPM), template-based intra mode derivation (TIMD) and decoder-side intra mode derivation (DIMD), the parallel mode for the block boundary of the geometric partition mode, and the perpendicular mode for the block boundary of the geometric partition mode are used.

The candidates of the candidate list of the two intra-prediction modes combined are sorted in ascending order of the template-based Sum of Absolute Transformed Differences (SATD). The length of the candidate list of the combined candidates may be set to 16. The video decoding apparatus determines partitioning direction information by using the signaled index, and uses the signaled index to determine intra-prediction modes for the two regions from the candidate list of the two intra-prediction modes combined. Here, the width of a weighted-summation region subject to a weighted summation within the current block may be implicitly determined based on the height and width of the current block.

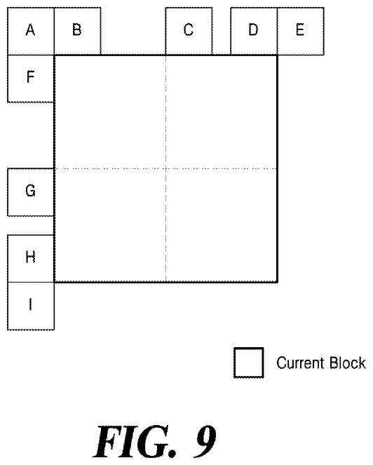

FIG. 9 is a diagram illustrating reconstructed neighbor blocks of a current block, according to at least one embodiment of the present disclosure.

Referring to FIG. 9, the reconstructed neighbor blocks of the current block may be A block, B block, C block, D block, E block, F block, G block, H block, and I block. When a geometric partitioning mode is applied to the current block, the video encoding apparatus may search the A block, B block, C block, D block, E block, F block, G block, H block, and I block to generate combined candidate list of intra-prediction modes for partitioned regions. Here, the search order may be predefined by the video encoding apparatus and the video decoding apparatus. Where the current block is partitioned into region 0 and region 1, the combined candidate list of intra-prediction modes for the respective partitioned regions may include the candidate list of intra-prediction modes of region 0 and the candidate list of intra-prediction modes of region 1. The search order may vary based on the aspect ratio of the current block. The video encoding apparatus may search just the neighbor blocks of the current region for each partitioned region.

Where the searched block underwent the intra prediction, the video encoding apparatus may add the intra-prediction mode of the intra-prediction block, to the combined candidate list of intra-prediction modes of the respective partitioned regions. Where the searched block underwent the geometric partitioning mode, the video encoding apparatus may add the intra-prediction mode corresponding to the directionality of the geometric partition boundary of the geometrically partitioned block, to the combined candidate list of intra-prediction modes of the respective partitioned regions.

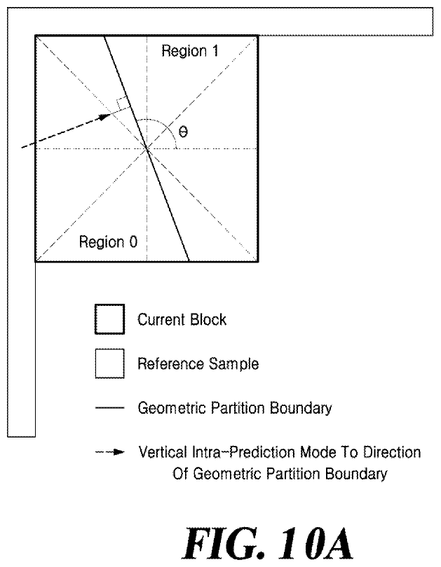

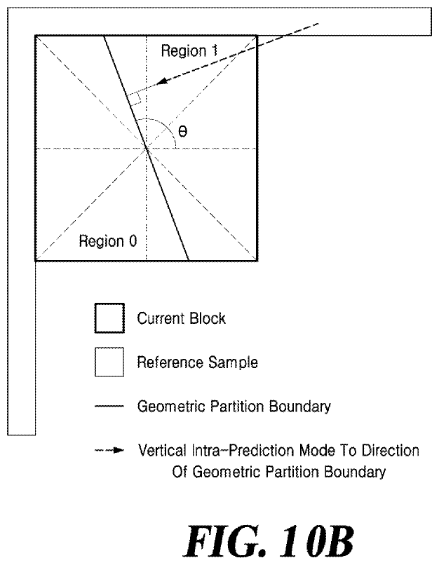

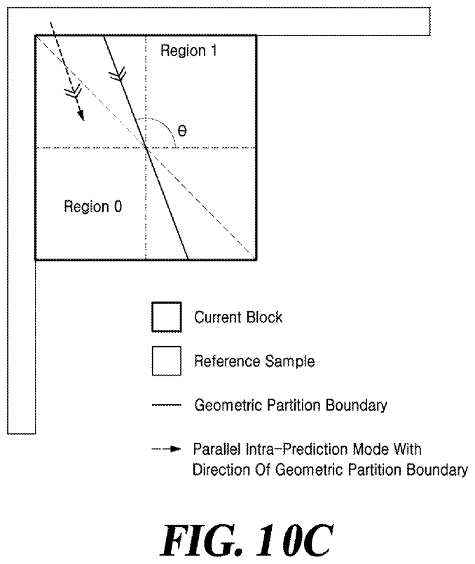

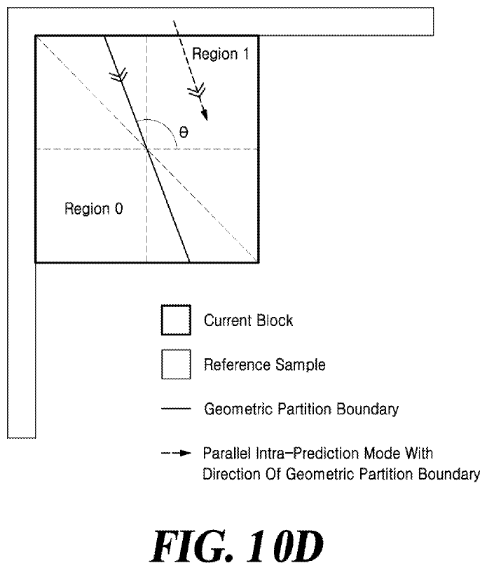

FIG. 10A, FIG. 10B, FIG. 10C, and FIG. 10D are diagrams illustrating methods of generating a combined candidate list of intra-prediction modes for the respective partitioned regions in a geometric partitioning mode, according to some embodiments of the present disclosure.

Referring to FIG. 10A and FIG. 10B, when a geometric partitioning mode is applied to the current block, the latter may be partitioned into region 0 and region 1. The video encoding apparatus may add an intra-prediction mode corresponding to the direction of the geometric partition boundary and an intra-prediction mode corresponding to the perpendicular direction to the direction of the geometric partition boundary, to the candidate list of intra-prediction modes for each region. The angle θ of the geometric partition boundary may be arbitrary.

Referring to FIG. 10C and FIG. 10D, when a geometric partitioning mode is applied to the current block, the latter may be partitioned into region 0 and region 1. The video encoding apparatus may add an intra-prediction mode corresponding to the direction of the geometric partition boundary and an intra-prediction mode corresponding to the horizontal direction with the direction of the geometric partition boundary, to the candidate list of intra-prediction modes for each region. The angle θ of the geometric partition boundary may be arbitrary.

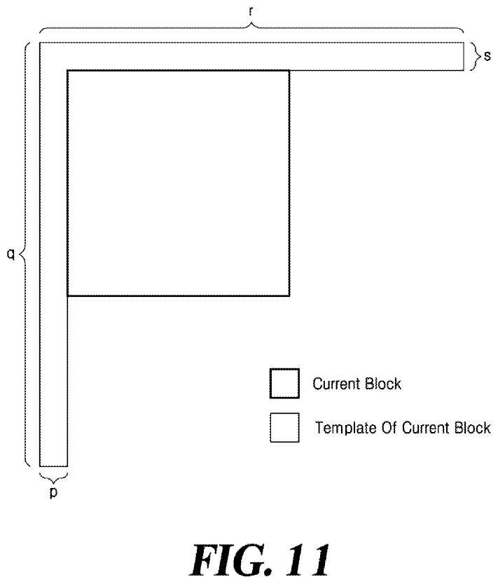

FIG. 11 is a diagram illustrating a current block and a template according to at least one embodiment of the present disclosure.

Referring to FIG. 11, the template of the current block may be present at the left, bottom left, top left, top, and top right of the current block. Here, p, q, r, and s may be integers greater than or equal to 1. When the template of the current block is available, the video encoding apparatus by using intra-prediction modes of neighboring blocks of the current block to determine a Most Probable Mode list (MPM list). The video encoding apparatus generates a prediction template by applying the directionality of all candidate modes in the MPM list to the reference pixels of the template. The sum of absolute transformed differences (SATD) may be calculated between the pixels of the generated prediction template and the pixels of the reconstructed template. The mode with the smallest sum of absolute transformed differences among the candidate modes in the MPM list may be the intra-prediction mode determined by using the template of the current block. The video encoding apparatus may add the intra-prediction mode determined by using the template of the current block, to the combined candidate list of intra-prediction modes for the respective partitioned regions.

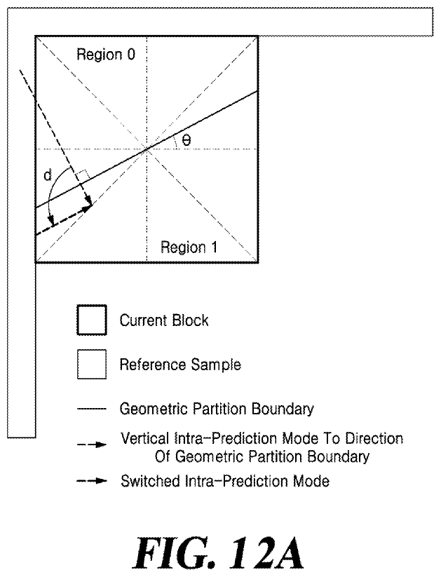

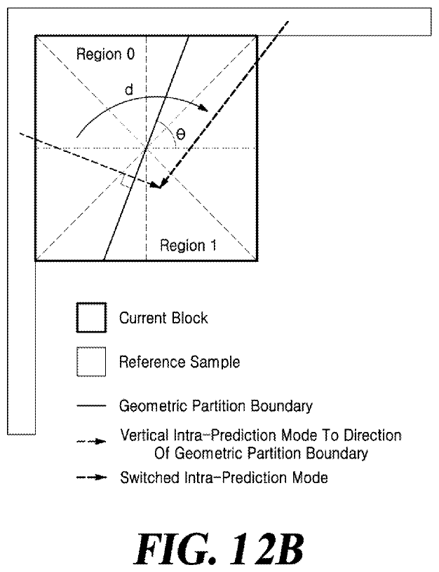

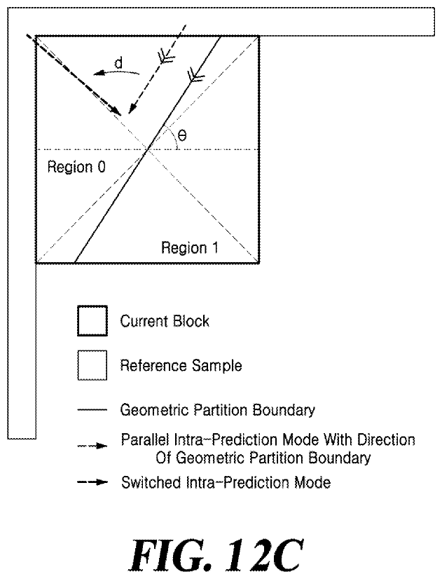

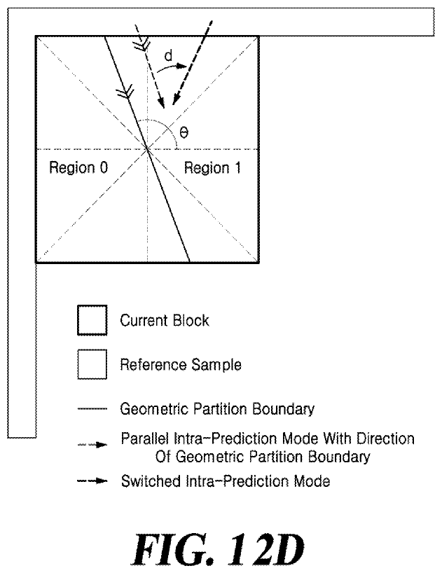

FIGS. 12A, 12B, 12C, and 12D are diagrams illustrating methods of generating a combined candidate list of intra-prediction modes for the respective regions in a geometric partitioning mode, according to other embodiments of the present disclosure.

Referring to FIG. 12A, when the geometric partitioning mode is applied to the current block, the current block may be partitioned into region 0 and region 1. The video encoding apparatus may add a switched intra-prediction mode that corresponds to the perpendicular angle to the direction of the geometric partition boundary plus an offset d, to the candidate list of intra-prediction modes for each region. The angle θ of the geometric partition boundary may be arbitrary.

Referring to FIG. 12B, when the geometric partitioning mode is applied to the current block, the current block may be partitioned into region 0 and region 1. The video encoding apparatus may add a switched intra-prediction mode that corresponds to the perpendicular angle to the direction of the geometric partition boundary minus an offset d, to the candidate list of intra-prediction modes for each region. The angle θ of the geometric partition boundary may be arbitrary.

Referring to FIG. 12C, when the geometric partitioning mode is applied to the current block, the current block may be partitioned into region 0 and region 1. The video encoding apparatus may add a switched intra-prediction mode that corresponds to the parallel direction with the geometric partition boundary plus an offset d, to the candidate list of intra-prediction modes for each region. The angle θ of the geometric partition boundary may be arbitrary.

Referring to FIG. 12D, when the geometric partitioning mode is applied to the current block, the current block may be partitioned into region 0 and region 1. The video encoding apparatus may add a switched intra-prediction mode that corresponds to the parallel direction with the geometric partition boundary minus an offset d, to the candidate list of intra-prediction modes for each region. The angle θ of the geometric partition boundary may be arbitrary.

Here, the offset d may be a predefined value or a value determined based on the size of the current block and/or the aspect ratio of the current block. The offset d may be determined based on the angle θ of the geometric partition boundary.

Said switched intra-prediction mode corresponding to the perpendicular angle to the partition boundary direction plus offset d, and said switched intra-prediction mode corresponding to the perpendicular angle to the partition boundary direction minus offset d, may both be unavailable intra-prediction modes. In this case, the video encoding apparatus may add the intra-prediction mode with the closest angle to the directionality of the unavailable switched intra-prediction mode, to the combined candidate list of intra-prediction modes for the respective regions. Said switched intra-prediction mode corresponding to the perpendicular angle to the partition boundary direction plus offset d, and said switched intra-prediction mode corresponding to the perpendicular angle to the partition boundary direction minus offset d, may both be available. In this case, the video encoding apparatus may add an intra-prediction mode referring to an available reference sample, to the combined candidate list of intra-prediction modes for the respective regions.

Said switched intra-prediction mode corresponding to the perpendicular angle to the partition boundary direction plus offset d, and said switched intra-prediction mode corresponding to the perpendicular angle to the partition boundary direction minus offset d, may both be available. In this case, the video encoding apparatus may add one between the two switched intra-prediction modes, which uses a reference sample that is closer to a specific region, to the combined candidate list of intra-prediction modes for the respective regions. Said switched intra-prediction mode corresponding to the perpendicular angle to the partition boundary direction plus offset d, and said switched intra-prediction mode corresponding to the perpendicular angle to the partition boundary direction minus offset d, may both be available. In this case, the video encoding apparatus may add the switched intra-prediction mode determined based on the aspect ratio of the current block between the two switched intra-prediction modes, to the combined candidate list of intra-prediction modes for the respective regions.

Said switched intra-prediction mode corresponding to the parallel direction with the geometric partition boundary plus offset d, and said switched intra-prediction mode corresponding to the parallel direction with the geometric partition boundary minus offset d, may both be unavailable intra-prediction modes. In this case, the video encoding apparatus may add an intra-prediction mode having the closest angle to the direction of the unavailable switched intra-prediction mode, to the combined candidate list of intra-prediction modes for the respective regions. Said switched intra-prediction mode corresponding to the parallel direction with the geometric partition boundary plus offset d, and said switched intra-prediction mode corresponding to the parallel direction with the geometric partition boundary minus offset d, may both be available. In this case, the video encoding apparatus may add an intra-prediction mode referring to the available reference sample, to the combined candidate list of intra-prediction modes for the respective regions.

Said switched intra-prediction mode corresponding to the parallel direction with the geometric partition boundary plus offset d, and said switched intra-prediction mode corresponding to the parallel direction with the geometric partition boundary minus offset d, may both be available. In this case, the video encoding apparatus may add an intra-prediction mode that uses a reference sample closer to a specific region between the two intra-prediction modes, to the combined candidate list of intra-prediction modes for the respective regions. Said switched intra-prediction mode corresponding to the parallel direction with the geometric partition boundary plus offset d, and said switched intra-prediction mode corresponding to the parallel direction with the geometric partition boundary minus offset d, may both be available. In this case, the video encoding apparatus may add the switched intra-prediction mode determined based on the aspect ratio of the current block between the two switched intra-prediction modes, to the combined candidate list of intra-prediction modes for the respective regions.

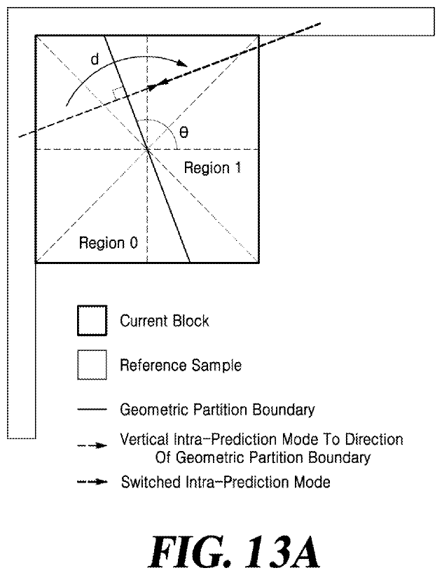

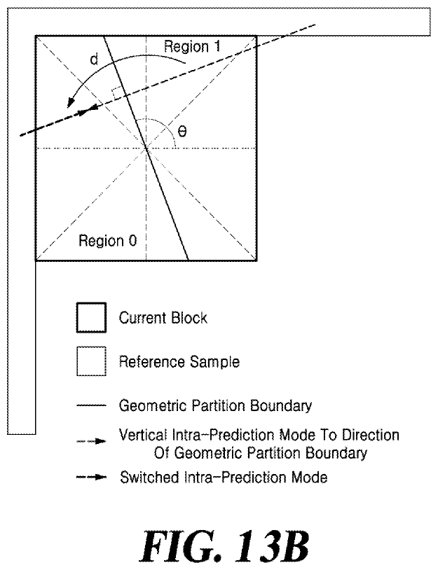

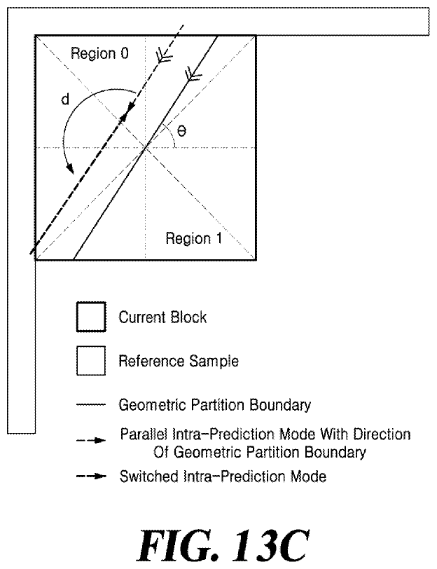

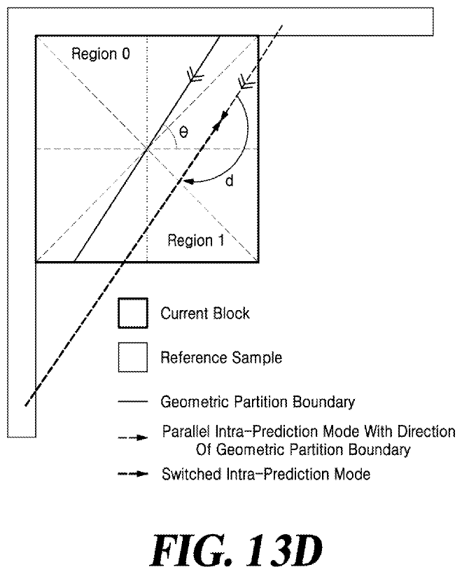

FIG. 13A, FIG. 13B, FIG. 13C and FIG. 13D are diagrams illustrating methods of generating a combined candidate list of intra-prediction modes for respective regions in a geometric partitioning mode, according to yet other embodiments of the present disclosure.

Referring to FIG. 13A, when the geometric partitioning mode is applied to the current block, the latter may be partitioned into region 0 and region 1. The video encoding apparatus may add a switched intra-prediction mode corresponding to the perpendicular angle to the direction of the geometric partition boundary minus an offset d, to the candidate list of intra-prediction modes for each region. Here, the angle θ of the geometric partition boundary may be arbitrary, and the offset d may be 180°.

Referring to FIG. 13B, when the geometric partitioning mode is applied to the current block, the latter may be partitioned into region 0 and region 1. The video encoding apparatus may add a switched intra-prediction mode corresponding to a perpendicular angle to the direction of the geometric partition boundary plus an offset d, to the candidate list of intra-prediction modes for each region. Here, the angle θ of the geometric partition boundary may be arbitrary, and the offset d may be 180°.

Referring to FIG. 13C, when the geometric partitioning mode is applied to the current block, the latter may be partitioned into region 0 and region 1. The video encoding apparatus may add a switched intra-prediction mode corresponding to a parallel angle to the direction of the geometric partition boundary plus an offset d, to the candidate list of intra-prediction modes for each region. Here, the angle θ of the geometric partition boundary may be arbitrary, and the offset d may be 180°.

Referring to FIG. 13D, when the geometric partitioning mode is applied to the current block, the latter may be partitioned into region 0 and region 1. The video encoding apparatus may add a switched intra-prediction mode corresponding to a parallel angle to the direction of the geometric partition boundary minus an offset d, to the candidate list of intra-prediction modes for each region. Here, the angle θ of the geometric partition boundary may be arbitrary, and the offset d may be 180°.

Each switched intra-prediction mode corresponding to the perpendicular angle to the direction of the geometric partition boundary plus or minus offset d, may be an unavailable intra-prediction mode. In this case, the video encoding apparatus may add an intra-prediction mode having an angle closest to the directionality of the unavailable switched intra-prediction mode, to the combined candidate list of intra-prediction modes for the respective regions.

Each switched intra-prediction mode corresponding to the parallel angle to the direction of the geometric partition boundary plus or minus offset d, may be an unavailable intra-prediction mode. In this case, the video encoding apparatus may add an intra-prediction mode having an angle closest to the directionality of the unavailable switched intra-prediction mode to the combined candidate list of intra-prediction modes for the respective regions.

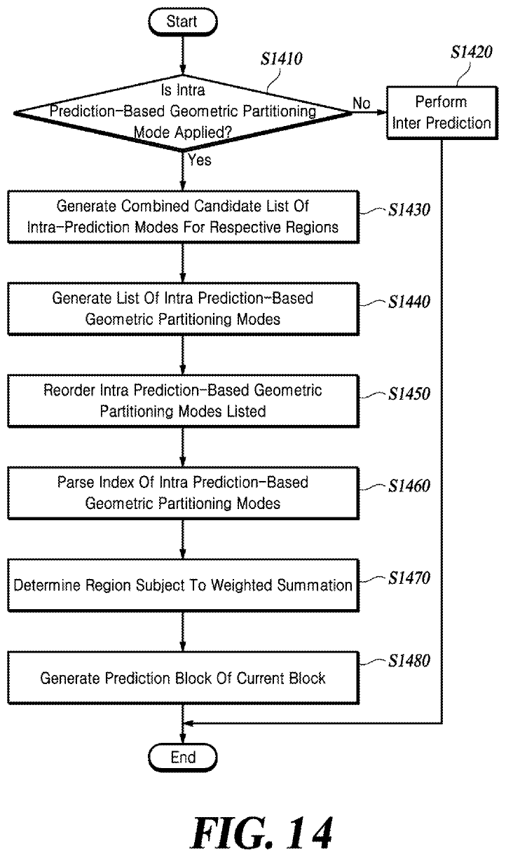

FIG. 14 is a flowchart of a process for generating a prediction block of a current block by using an intra prediction-based geometric partitioning mode according to at least one embodiment of the present disclosure.

Referring to FIG. 14, the video encoding apparatus determines whether the intra prediction-based geometric partitioning mode is applied to the current block (S1410). The intra prediction-based geometric partitioning mode may be a mode in which intra prediction is applied to all partitioned regions of the current block. If it is determined that the intra prediction-based geometric partitioning mode is not applied to the current block (S1410-NO), the video encoding apparatus performs inter prediction on the current block (S1420). If it is determined that the intra prediction-based geometric partitioning mode is applied to the current block (S1410-YES), the video encoding apparatus generates a candidate list of intra-prediction modes for each region (S1430). The video encoding apparatus generates an intra prediction-based geometric partitioning mode list (S1440). If the current block is partitioned into region 0 and region 1, the intra prediction-based geometric partitioning mode list may be a list including intra prediction mode candidates for region 0, intra prediction mode candidates for region 1, and partitioning direction information. The video encoding apparatus rearranges the intra prediction-based geometric partitioning mode list (S1450). The video encoding apparatus may rearrange the intra prediction-based geometric partitioning mode list by using a loss function based on a template of the current block. Here, the template of the current block is a reconstructed region adjacent to the current block. The loss function may be Sum of Absolute Differences (SAD), Sum of Absolute Transformed Differences (SATD), etc.

The video encoding apparatus parses an index for the intra prediction-based geometric partitioning mode (S1460). The video decoding apparatus may use the index for the intra-prediction-based geometric partitioning mode to determine, from the intra prediction-based geometric partitioning mode list, the intra-prediction mode for region 0, the intra-prediction mode for region 1, and partitioning direction information. The video encoding apparatus determines the region subject to the weighted summation (S1470). The video encoding apparatus may determine the region subject to the weighted summation by using the prediction samples of region 0 and region 1. The video encoding apparatus may parse the index for the region subject to the weighted summation. A weighted sum matrix may be determined based on the region subject to the weighted summation. The video encoding apparatus generates the prediction block of the current block (S1480).

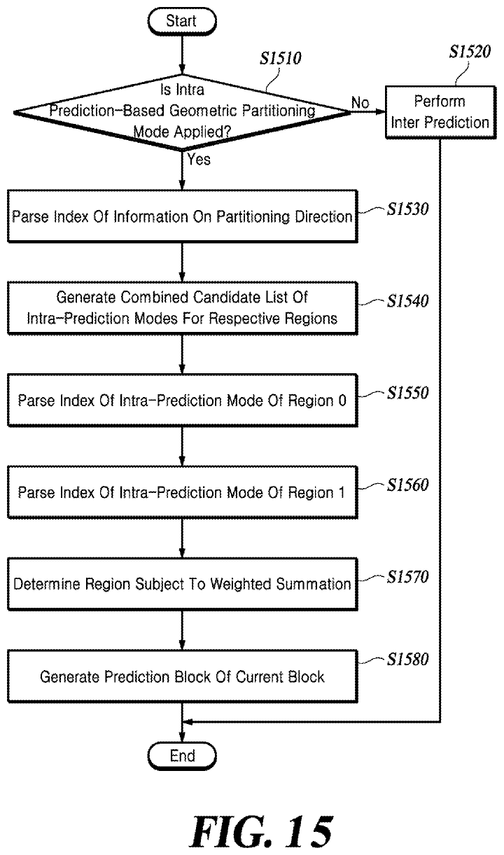

FIG. 15 is a flowchart of a process of generating a prediction block of a current block by using an intra prediction-based geometric partitioning mode according to another embodiment of the present disclosure.

Referring to FIG. 15, the video encoding apparatus determines whether the intra prediction-based geometric partitioning mode is applied to the current block (S1510). If it is determined that the intra prediction-based geometric partitioning mode is not applied to the current block (S1510-NO), the video encoding apparatus performs inter prediction on the current block (S1520). If it is determined that the intra prediction-based geometric partitioning mode is applied to the current block (S1510-YES), the video encoding apparatus parses an index for partitioning direction information (S1530). The partitioning direction information may be predefined as a table. The video encoding apparatus generates a candidate list of intra-prediction modes for each of regions (S1540). The video encoding apparatus parses an index for the intra-prediction mode of region 0 (S1550). The video encoding apparatus parses an index for the intra-prediction mode of region 1 (S1560). The video decoding apparatus may use the index for the intra-prediction mode of region 0 and the index for the intra-prediction mode of region 1 to determine the intra-prediction modes for the respective regions. As another embodiment, after Step S1540 is performed, the video encoding apparatus may parse the index for the partitioning direction information.

The video encoding apparatus determines the region subject to the weighted summation (S1570). The video encoding apparatus may determine the region subject to the weighted summation by using the prediction samples of region 0 and region 1. The video encoding apparatus may parse the index for the region subject to the weighted summation. A weighted sum matrix may be determined based on the region subject to the weighted summation. The video encoding apparatus generates the prediction block of the current block (S1580).

The weighted sum matrix is W_{B}^{f} which is used along with the predicted signals of the respective regions to calculate the predicted signal of the current block. Here, the prediction signal of the current block is P_{G}(i, j) which may be expressed as in Equation 1.

$${P}_{G} ( i , j ) = ( {W}_{B}^{f} ( i , j ) \times {P}_{0} + ( {2}^{w} - {W}_{B}^{f} ( i , j ) ) \times {P}_{1} + ( {2}^{w - 1} ) ) ≫ w \qquad Equation 1$$

Here, W_{B}^{f}(i, j) is a weighted sum matrix, P₀ is a prediction signal for region 0, P₁ is a prediction signal for region 1, and w may be an integer greater than or equal to 1. w may be a predefined value and may be determined based on the size of the current block.

### Intra Prediction-Based Geometric Partitioning Mode for Chroma Blocks

When an intra prediction-based geometric partitioning mode is applied to a chroma block, the video decoding apparatus may do color format-based sampling of the chroma block's co-located luma block's region that is subject to the weighted summation, partitioning direction information, an intra-prediction mode of region 0, and an intra-prediction mode of region 1 to generate a prediction signal of the chroma block.

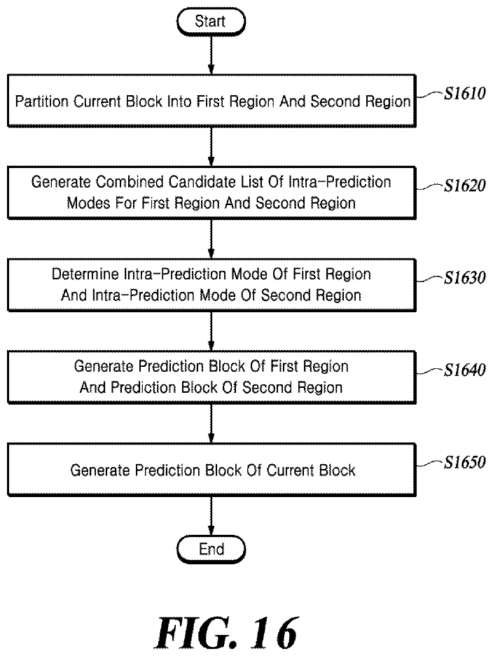

FIG. 16 is a flowchart of a video decoding process according to at least one embodiment of the present disclosure.

Referring to FIG. 16, the video decoding apparatus partitions the current block into the first region and the second region (S1610). The video decoding apparatus generates a combined candidate list of intra-prediction modes for the first region and the second region based on at least one of reference blocks adjacent to the current block, a geometric partition boundary, or a third region adjacent to the current block (S1620). The process of generating the combined candidate list of intra-prediction modes may include, when the neighboring reference blocks of the current block include blocks that underwent the intra prediction, a process of adding intra-prediction modes of the intra-prediction blocks, to the combined candidate list of intra-prediction modes. Further, the process of generating the combined candidate list of intra-prediction modes may include, when the neighboring reference blocks of the current block include blocks that underwent the geometric partitioning mode, a process of adding intra-prediction modes that are based on geometric partition boundaries of the geometrically partitioned blocks, to the combined candidate list of intra-prediction modes.

The process of generating the combined candidate list of intra-prediction modes may include a process of adding a first intra-prediction mode based on the geometric partition boundary of the current block and a second intra-prediction mode corresponding to a perpendicular direction to the direction of the first intra-prediction mode, to the combined candidate list of intra-prediction modes. The process of generating the combined candidate list of intra-prediction modes may include a process of adding the first intra-prediction mode based on the geometric partition boundary of the current block and a third intra-prediction mode corresponding to a parallel direction with the direction of the first intra-prediction mode, to the combined candidate list of intra-prediction modes.

The process of generating the combined candidate list of intra-prediction modes may include a process of generating one or more prediction pixels by applying one or more candidate modes in the MPM list of the current block to one or more reference pixels of the third region, a process of calculating variable values based on differences between one or more prediction pixels and one or more reconstructed pixels of the third region, and a process of adding an intra-prediction mode determined based on the variable values, to the combined candidate list of intra-prediction modes.

The process of generating the combined candidate list of intra-prediction modes may include a process of determining a fourth intra-prediction mode by subtracting or adding an offset from or to a perpendicular direction perpendicular to the direction of the geometric partition boundary of the current block, and a process of adding the fourth intra-prediction mode to the combined candidate list of intra-prediction modes. The offset may be determined based on an angle of the geometric partition boundary, a size of the current block, and an aspect ratio of the current block.

The process of generating the combined candidate list of intra-prediction modes may include a process of determining a fifth intra-prediction mode by subtracting or adding an offset from or to a horizontal direction with the direction of the geometric partition boundary of the current block, and a process of adding the fifth intra-prediction mode to the combined candidate list of intra-prediction modes. The offset may be determined based on an angle of the geometric partition boundary, a size of the current block, and an aspect ratio of the current block.

The process of generating the combined candidate list of intra-prediction modes may include a process of generating the combined candidate list of intra-prediction modes by using partitioning direction information, and a process of rearranging the combined candidate list of intra-prediction modes by using variable values based on the third region of the current block.

The video decoding apparatus use the combined candidate list of intra-prediction modes to determine an intra-prediction mode of the first region and an intra-prediction mode of the second region (S1630). The video decoding apparatus by using the intra-prediction mode of the first region and the intra-prediction mode of the second region to generate a prediction block of the first region and a prediction block of the second region (S1640). The video decoding apparatus uses the prediction block of the first region and the prediction block of the second region to generate a prediction block of the current block (S1650).

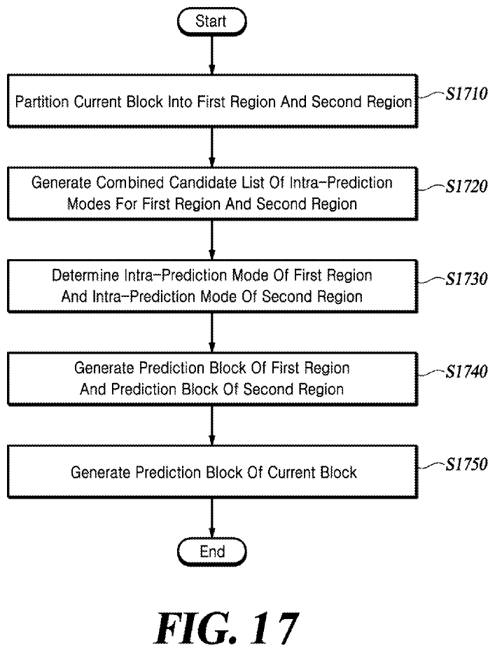

FIG. 17 is a flowchart of a video encoding process according to at least one embodiment of the present disclosure.

Referring to FIG. 17, the video encoding apparatus partitions the current block into the first region and the second region (S1710). The video encoding apparatus generates a combined candidate list of intra-prediction modes for the first region and the second region based on at least one of reference blocks adjacent to the current block, a geometric partition boundary, and a third region adjacent to the current block (S1720). The process of generating the combined candidate list of intra-prediction modes may include, when the neighboring reference blocks of the current block include blocks that underwent the intra prediction, a process of adding intra-prediction modes of the intra-prediction blocks, to the combined candidate list of intra-prediction modes. Further, the process of generating the combined candidate list of intra-prediction modes may include, when the neighboring reference blocks of the current block include blocks that underwent the geometric partitioning mode, a process of adding intra-prediction modes that are based on geometric partition boundaries of the geometrically partitioned blocks, to the combined candidate list of intra-prediction modes.

The process of generating the combined candidate list of intra-prediction modes may include a process of adding a first intra-prediction mode based on the geometric partition boundary of the current block and a second intra-prediction mode corresponding to a perpendicular direction to the direction of the first intra-prediction mode, to the combined candidate list of intra-prediction modes. The process of generating the combined candidate list of intra-prediction modes may include a process of adding the first intra-prediction mode based on the geometric partition boundary of the current block and a third intra-prediction mode corresponding to a parallel direction with the direction of the first intra-prediction mode, to the combined candidate list of intra-prediction modes.

The process of generating the combined candidate list of intra-prediction modes may include a process of generating one or more prediction pixels by applying one or more candidate modes in the MPM list of the current block to one or more reference pixels of the third region, a process of calculating variable values based on differences between one or more prediction pixels and one or more reconstructed pixels of the third region, and a process of adding an intra-prediction mode determined based on the variable values, to the combined candidate list of intra-prediction modes.

The process of generating the combined candidate list of intra-prediction modes may include a process of determining a fourth intra-prediction mode by subtracting or adding an offset from or to a perpendicular direction to the direction of the geometric partition boundary of the current block, and a process of adding the fourth intra-prediction mode to the combined candidate list of intra-prediction modes. The offset may be determined based on an angle of the geometric partition boundary, a size of the current block, and an aspect ratio of the current block.

The process of generating the combined candidate list of intra-prediction modes may include a process of determining a fifth intra-prediction mode by subtracting or adding an offset from or to a horizontal direction with the direction of the geometric partition boundary of the current block, and a process of adding the fifth intra-prediction mode to the combined candidate list of intra-prediction modes. The offset may be determined based on an angle of the geometric partition boundary, a size of the current block, and an aspect ratio of the current block.

The process of generating the combined candidate list of intra-prediction modes may include a process of generating the combined candidate list of intra-prediction modes by using partitioning direction information, and a process of rearranging the combined candidate list of intra-prediction modes by using variable values based on the third region of the current block.

The video encoding apparatus uses the combined candidate list of intra-prediction modes to determine an intra-prediction mode of the first region and an intra-prediction mode of the second region (S1730). The video encoding apparatus uses the intra-prediction mode of the first region and the intra-prediction mode of the second region to generate a prediction block of the first region and a prediction block of the second region (S1740). The video encoding apparatus uses the prediction block of the first region and the prediction block of the second region to generate a prediction block of the current block (S1750).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

1. A video decoding method, comprising:
partitioning a current block into a first region and a second region;
generating a combined candidate list of intra-prediction modes for the first region and the second region based on at least one of a set of reference blocks adjacent to the current block, a geometric partition boundary of the current block, or a third region adjacent to the current block;
determining an intra-prediction mode of the first region and an intra-prediction mode of the second region by using the combined candidate list of intra-prediction modes;
generating a prediction block of the first region and a prediction block of the second region by using the intra-prediction mode of the first region and the intra-prediction mode of the second region; and
generating a prediction block of the current block by using the prediction block of the first region and the prediction block of the second region.

2. The video decoding method of claim 1, wherein generating the combined candidate list of intra-prediction modes comprises:
when there are reference blocks on which an intra prediction has been performed among the reference blocks adjacent to the current block, adding intra-prediction modes of the reference blocks on which the intra prediction has been performed, to the combined candidate list of intra-prediction modes; and
when there are reference blocks on which a geometric partitioning mode has been performed among the reference blocks adjacent to the current block, adding intra-prediction modes that are based on geometric partition boundaries of the reference blocks on which the geometric partitioning mode has been performed, to the combined candidate list of intra-prediction modes.

3. The video decoding method of claim 1, wherein generating the combined candidate list of intra-prediction modes comprises:
adding a first intra-prediction mode based on the geometric partition boundary of the current block and a second intra-prediction mode corresponding to a perpendicular direction to a direction of the first intra-prediction mode, to the combined candidate list of intra-prediction modes.

4. The video decoding method of claim 1, wherein generating the combined candidate list of intra-prediction modes comprises:
adding a first intra-prediction mode based on the geometric partition boundary of the current block and a third intra-prediction mode corresponding to a horizontal direction to a direction of the first intra-prediction mode, to the combined candidate list of intra-prediction modes.

5. The video decoding method of claim 1, wherein generating the combined candidate list of intra-prediction modes comprises:
generating one or more predicted pixels by applying one or more candidate modes in an MPM list of the current block to one or more reference pixels in the third region;
calculating variable values based on differences between the one or more predicted pixels and one or more reconstructed pixels in the third region; and
adding an intra-prediction mode determined based on the variable values to the combined candidate list of intra-prediction modes.

6. The video decoding method of claim 1, wherein generating the combined candidate list of intra-prediction modes comprises:
determining a fourth intra-prediction mode by subtracting or adding an offset from or to a perpendicular direction to a direction of the geometric partition boundary of the current block; and
adding the fourth intra-prediction mode to the combined candidate list of intra-prediction modes.

7. The video decoding method of claim 6, wherein the offset is determined based on an angle of the geometric partition boundary, a size of the current block, and an aspect ratio of the current block.

8. The video decoding method of claim 1, wherein generating the combined candidate list of intra-prediction modes comprises:
determining a fifth intra-prediction mode by subtracting or adding an offset from or to a horizontal direction to a direction of the geometric partition boundary of the current block; and
adding the fifth intra-prediction mode to the combined candidate list of intra-prediction modes.

9. The video decoding method of claim 8, wherein the offset is determined based on an angle of the geometric partition boundary, a size of the current block, and an aspect ratio of the current block.

10. The video decoding method of claim 1, wherein generating the combined candidate list of intra-prediction modes comprises:
generating the combined candidate list of intra-prediction modes by using partitioning direction information; and
rearranging the combined candidate list of intra-prediction modes by using variable values based on the third area of the current block.

11. A video encoding method, comprising:
partitioning a current block into a first region and a second region;
generating a combined candidate list of intra-prediction modes for the first region and the second region based on at least one of a set of reference blocks adjacent to the current block, a geometric partition boundary of the current block, or a third region adjacent to the current block;
determining an intra-prediction mode of the first region and an intra-prediction mode of the second region by using the combined candidate list of intra-prediction modes;
generating a prediction block of the first region and a prediction block of the second region by using the intra-prediction mode of the first region and the intra-prediction mode of the second region; and
generating a prediction block of the current block by using the prediction block of the first region and the prediction block of the second region.

12. The video encoding method of claim 11, wherein the generating of the combined candidate list of intra-prediction modes comprises:
when there are reference blocks on which an intra prediction mode has been performed among the reference blocks adjacent to the current block, adding intra-prediction modes of the reference blocks on which the intra prediction has been performed, to the combined candidate list of intra-prediction modes; and
when there are reference blocks on which a geometric partitioning mode has been performed among the reference blocks adjacent to the current block, adding intra-prediction modes that are based on geometric partition boundaries of the reference blocks on which the geometric partitioning mode has been performed, to the combined candidate list of intra-prediction modes.

13. The video encoding method of claim 11, wherein generating the combined candidate list of intra-prediction modes comprises:
adding a first intra-prediction mode based on the geometric partition boundary of the current block and a second intra-prediction mode corresponding to a perpendicular direction to a direction of the first intra-prediction mode, to the combined candidate list of intra-prediction modes.

14. The video encoding method of claim 11, wherein generating the combined candidate list of intra-prediction modes comprises:
adding a first intra-prediction mode based on the geometric partition boundary of the current block and a third intra-prediction mode corresponding to a horizontal direction to a direction of the first intra-prediction mode, to the combined candidate list of intra-prediction modes.

15. The video encoding method of claim 11, wherein generating the combined candidate list of intra-prediction modes comprises:
generating one or more predicted pixels by applying one or more candidate modes in an MPM list of the current block to one or more reference pixels in the third region;
calculating variable values based on differences between the one or more predicted pixels and one or more reconstructed pixels in the third region; and
adding an intra-prediction mode determined based on the variable values to the combined candidate list of intra-prediction modes.

16. The video encoding method of claim 11, wherein generating the combined candidate list of intra-prediction modes comprises:
determining a fourth intra-prediction mode by subtracting or adding an offset from or to a perpendicular direction to a direction of the geometric partition boundary of the current block; and
adding the fourth intra-prediction mode to the combined candidate list of intra-prediction modes.

17. The video encoding method of claim 16, wherein the offset is determined based on an angle of the geometric partition boundary, a size of the current block, and an aspect ratio of the current block.

18. The video encoding method of claim 11, wherein generating the combined candidate list of intra-prediction modes comprises:
determining a fifth intra-prediction mode by subtracting or adding an offset from or to a horizontal direction to a direction of the geometric partition boundary of the current block; and
adding the fifth intra-prediction mode to the combined candidate list of intra-prediction modes.

19. The video encoding method of claim 11, wherein generating the combined candidate list of intra-prediction modes comprises:
generating the combined candidate list of intra-prediction modes by using partitioning direction information; and
rearranging the combined candidate list of intra-prediction modes by using variable values based on the third area of the current block.

20. A method of transmitting a bitstream related to video data, the method comprising:
generating the bitstream by encoding the video data; and
transmitting the bitstream to a video decoding apparatus,
wherein the generating of the bitstream comprises:
partitioning a current block into a first region and a second region;
generating a combined candidate list of intra-prediction modes for the first region and the second region based on at least one of a set of reference blocks adjacent to the current block, a geometric partition boundary of the current block, or a third region adjacent to the current block;
determining an intra-prediction mode of the first region and an intra-prediction mode of the second region by using the combined candidate list of intra-prediction modes;
generating a prediction block of the first region and a prediction block of the second region by using the intra-prediction mode of the first region and the intra-prediction mode of the second region; and
generating a prediction block of the current block by using the prediction block of the first region and the prediction block of the second region.
